(19) United States
(12) Patent Application Publication
(10) Pub. No.: US 2016/0124396 A1
(43) Pub. Date: May 5, 2016

(54) ANTENNA APPARATUS AND ELECTRONIC DEVICE HAVING THE SAME

(71) Applicant: Samsung Electronics Co., Ltd., Suwon-si (KR)

(72) Inventors: Sang-Hoon CHOI, Suwon-si (KR); Tae-Young KIM, Suwon-si (KR); Yoon-Jae LEE, Seoul (KR); In-Young LEE, Hwaseong-si (KR); Won-Seok JEONG, Suwon-si (KR); Brian CHEON, Suwon-si (KR)

(21) Appl. No.: 14/928,510

(22) Filed: Oct. 30, 2015

(30) Foreign Application Priority Data
Nov. 4, 2014 (KR) 10-2014-0152321

(51) Int. Cl. G04G 17/08; G04B 37/00; G04G 21/08; G04G 21/04; H01Q 1/24; H01Q 1/27

(52) U.S. Cl. CPC G04G 17/08; H01Q 1/243; H01Q 1/273; G04G 21/08; G04G 21/04; G04B 37/0008

(57) ABSTRACT

An electronic device is provided. The electronic device includes a housing comprising a recess portion formed along an edge of the housing, a sealing member arranged in the recess portion, so as to provide a seal between structures coupled with the housing, an antenna member disposed in at least a portion of the sealing member, and a substrate electrically connected with the antenna member.

### CROSS-REFERENCE TO RELATED APPLICATION(S)

This application claims the benefit under 35 U.S.C. §119(a) of a Korean patent application filed on Nov. 4, 2014 in the Korean Intellectual Property Office and assigned Serial number 10-2014-0152321, the entire disclosure of which is hereby incorporated by reference.

### TECHNICAL FIELD

The present disclosure relates to an electronic device. More particularly, the present disclosure relates to an electronic device having an antenna apparatus.

### BACKGROUND

Recent growth of electronic telecommunication technologies has led to the emergence of electronic devices having various functions. In general, these electronic devices have convergence functions of performing one or more complex functions.

Starting with mobile terminals mainly classified into so-called “smartphones,” recently, wearable electronic devices worn on the human body have been introduced into the market. That is, these electronic devices are racing to get lightweight, thin, and small and concurrently have various functions in order to satisfy consumers' purchase desires.

As a functional gap of the latest electronic devices is noticeably decreased, the trend is to implement multifunction capabilities and concurrently become slimmer in order to satisfy consumers' interest. Particularly, wearable electronic devices (e.g., wrist wearable electronic devices, etc.) worn on the human body have no choice but to noticeably decrease a mounting space for electronic components for the sake of the maximization of portability and user convenience.

Generally, electronic devices may suffer a great deterioration of antenna radiation performance when using a case component of metal material in a situation in which a thickness of the device itself is thin and a mounting space for an antenna radiator is deficient in design aspects. For example, if components of metal material and internal and external structures of metal material exist around the antenna radiator, several phenomena such as a scattering effect by metals, an electromagnetic field confinement effect, mismatching, etc. may cause a sudden deterioration of the performance of the antenna radiator.

Previously, electronic devices have not had difficulties in manufacturing an antenna radiator because they have enough space to mount the antenna radiator and have a sufficient spaced distance with a metal component and make much use of dielectric substances such as plastics as external materials of the product. However, with the current portable electronic devices, it became difficult to obtain sufficient radiation performance using the existing antenna technologies, because a spaced distance between an antenna radiator and a metal component is decreases and a size of the metal structure becomes smaller or slimmer and frequently uses a metal as external materials so as to increase consumers' purchase desires.

A first method of the related art for addressing these problems may suffer the limitations of design owing to a required spaced distance between a metal and an antenna radiator. So, the first method does not use the metal up to the lowermost end of a terminal and provides a certain portion of the terminal as an antenna radiation space to apply injection.

A second method of the related art tunes an unspecific slot suitable to a frequency using a wide area of an adjacent battery cover when the battery cover, etc. are designed with a metal. This accompanies difficulties in determining whether it is of a shape in which the battery cover finally has which slot, because requiring many tunings for performance security. For example, an antenna was implemented by applying the slot to the metal battery cover, but this accompanies difficulties in which the tuning requires much time in applying to an actual model and a model different from an initial concept of a design is obtained according to a shape of the slot.

A third method of the related art may increase a cost due to an excessive deformation of a structure and added materials in a process of connecting a metal and an antenna, and may increase a thickness of an electronic device due to additional components.

Particularly, in a case of a global positioning system (GPS) antenna, a method for implementation of circular polarization of a small size antenna according to the related art is to install a metal square patch antenna whose corner portions are cut away on a high-permittivity ceramic element and feed to a coaxial probe in a suitable position on a patch. But, there is a problem in which the ceramic antenna is not suitable to a recently gradually miniaturized electronic device because having a big size.

The above information is presented as background information only to assist with an understanding of the present disclosure. No determination has been made, and no assertion is made, as to whether any of the above might be applicable as prior art with regard to the present disclosure.

### SUMMARY

Aspects of the present disclosure are to address at least the above-mentioned problems and/or disadvantages and to provide at least the advantages described below. Accordingly, an aspect of the present disclosure is to provide an antenna apparatus and an electronic device having the same.

Another aspect of the present disclosure is to provide an antenna apparatus and an electronic device having the same, implemented to prevent a deterioration of radiation performance caused by a reduction of an antenna radiator resulting from a miniaturization of the electronic device.

Another aspect of the present disclosure is to provide an antenna apparatus and an electronic device having the same, implemented to minimize affection to the human body and contribute to the implementation of smooth radiation performance.

Another aspect of the present disclosure is to provide an antenna apparatus and an electronic device having the same, implemented to exclude a separate antenna radiator mounting space to contribute to the slimness of the electronic device, by applying an antenna radiator using an existing metal member.

In accordance with an aspect of the present disclosure, an electronic device is provided. The electronic device includes a housing comprising a recess portion formed along an edge of the housing, a sealing member arranged in the recess portion, so as to provide a seal between structures coupled with the housing, an antenna member arranged in at least a portion of the sealing member, and a substrate electrically connected with the antenna member.

In accordance with another aspect of the present disclosure, an electronic device is provided. The electronic device includes an external housing comprising a recess portion formed along an edge of the external housing, a waterproof tape member disposed in the recess portion, so as to provide waterproofing between structures coupled to the external housing, an antenna member disposed in at least a portion of the waterproof tape member, and a substrate electrically connected with the antenna member, wherein the antenna member includes one feeding part and two grounding parts disposed in different positions, electrically connected to corresponding positions of the substrate, and operating as a multiple band antenna radiator.

Other aspects, advantages, and salient features of the disclosure will become apparent to those skilled in the art from the following detailed description, which, taken in conjunction with the annexed drawings, discloses various embodiments of the present disclosure.

### BRIEF DESCRIPTION OF THE DRAWINGS

The above and other aspects, features, and advantages of certain embodiments of the present disclosure will be more apparent from the following description taken in conjunction with the accompanying drawings, in which:

FIG. 1 is a diagram illustrating a network environment including an electronic device applied to a cradle according to an embodiment of the present disclosure;

FIGS. 2A and 2B are diagrams illustrating constructions of a front surface and a rear surface of an electronic device according to various embodiments of the present disclosure;

FIG. 3 is an exploded perspective diagram illustrating an electronic device according to an embodiment of the present disclosure;

FIG. 4A is a diagram illustrating a construction of a tape member including an antenna member according to an embodiment of the present disclosure;

FIG. 4B is a cutaway perspective diagram illustrating a state in which a tape member is installed in an electronic device according to an embodiment of the present disclosure;

FIG. 4C is a diagram illustrating a region by each operation frequency band in a case where an antenna member operates in a multiple band according to an embodiment of the present disclosure;

FIG. 4D is a diagram illustrating a construction of a tape member according to an embodiment of the present disclosure;

FIG. 5 is a graph showing a radiation characteristic in a case where an antenna member operates in a multiple band according to an embodiment of the present disclosure;

FIG. 6 is a diagram illustrating a construction of an antenna member applied to a tape member according to an embodiment of the present disclosure;

FIGS. 7A, 7B, 7C, and 7D are graphs showing a radiation characteristic of each radiation region of the antenna member of FIG. 6 according to various embodiments of the present disclosure; and

FIG. 8 is a block diagram illustrating a construction of an electronic device according to an embodiment of the present disclosure.

Throughout the drawings, it should be noted that like reference numbers are used to depict the same or similar elements, features, and structures.

### DETAILED DESCRIPTION

The following description with reference to the accompanying drawings is provided to assist in a comprehensive understanding of various embodiments of the present disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the present disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the present disclosure. Accordingly, it should be apparent to those skilled in the art that the following description of various embodiments of the present disclosure is provided for illustration purpose only and not for the purpose of limiting the present disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

The expressions “include” and/or “may include” used in the various embodiments of the present disclosure are intended to indicate a presence of a corresponding function, operation, or constitutional element disclosed herein, and it is not intended to limit a presence of one or more functions, operations, or constitutional elements. In addition, in the various embodiments of the present disclosure, the terms “include” and/or “have” are intended to indicate that characteristics, numbers, operations, constitutional elements, and elements disclosed in the specification or combinations thereof exist. As such, the terms “include” and/or “have” should be understood that there are additional possibilities of one or more other characteristics, numbers, operations, constitutional elements, elements or combinations thereof.

In various embodiments of the present disclosure, an expression “or” includes any and all combinations of words enumerated together. For example, “A or B” may include A or B, or may include both of A and B.

Although expressions used in various embodiments of the present disclosure, such as “1^{st},” “2^{nd},” “first,” and “second” may be used to express various constitutional elements of the various embodiments, it is not intended to limit the corresponding constitutional elements. For example, the above expressions are not intended to limit an order or an importance of the corresponding constitutional elements. The above expressions may be used to distinguish one constitutional element from another constitutional element. For example, a 1^{st} user device and the 2^{nd} user device are both user devices, and indicate different user devices. For example, a 1^{st} constitutional element may be termed a 2^{nd} constitutional element, and similarly, the 2^{nd} constitutional element may be termed the 1^{st} constitutional element without departing from the scope of the various embodiments of the present disclosure.

When a constitutional element is mentioned as being “connected” to or “accessing” another constitutional element, this may mean that it is directly connected to or accessing the other constitutional element, but it is to be understood that there are no intervening constitutional elements present. On the other hand, when a constitutional element is mentioned as being “directly connected” to or “directly accessing” another constitutional element, it is to be understood that there are no intervening constitutional elements present.

The terminology used in various embodiments of the present disclosure is for the purpose of describing particular embodiments only and is not intended to be limiting of the various embodiments of the present disclosure.

Unless otherwise defined, all terms (including technical and scientific terms) used herein have the same meaning as commonly understood by those ordinarily skilled in the art to which various embodiments of the present disclosure belong. It will be further understood that terms, such as those defined in commonly used dictionaries, should be interpreted as having a meaning that is consistent with their meaning in the context of the relevant art and the various embodiments of the present disclosure, and will not be interpreted in an idealized or overly formal sense unless expressly so defined herein.

An electronic device according to various embodiments of the present disclosure may be a device including an antenna capable of performing a communication function in at least one frequency band. For example, the electronic device may be a smart phone, a tablet personal computer (PC), a mobile phone, a video phone, an e-book reader, a desktop PC, a laptop PC, a netbook computer, a personal digital assistant (PDA), a portable multimedia player (PMP), a Moving Picture Experts Group (MPEG-1 or MPEG-2) Audio Layer 3 (MP3) player, a mobile medical device, a camera, and a wearable device (e.g., a head-mounted-device (HMD) such as electronic glasses, electronic clothes, an electronic bracelet, an electronic necklace, an electronic appcessory, an electronic tattoo, or a smart watch).

According to certain embodiments, the electronic device may be a smart home appliance having an antenna. For example, the smart home appliance may include at least one of a television (TV), a digital versatile disc (DVD) player, an audio, a refrigerator, an air conditioner, a cleaner, an oven, a microwave oven, a washing machine, an air purifier, a set-top box, a TV box (e.g., Samsung HomeSync™, Apple TV™, or Google TV™), a game console, an electronic dictionary, an electronic key, a camcorder, and an electronic picture frame.

According to certain embodiments, the electronic device including the antenna may be one of various medical devices (e.g., magnetic resonance angiography (MRA), magnetic resonance imaging (MRI), computed tomography (CT), imaging equipment, ultrasonic instrument, etc.), a navigation device, a global positioning system (GPS) receiver, an event data recorder (EDR), a flight data recorder (FDR), a car infotainment device, an electronic equipment for ship (e.g., a vessel navigation device, a gyro compass, etc.), avionics, a security device, a car head unit, an industrial or domestic robot, an automatic teller's machine (ATM) of a financial institution, and a point of sales (POS) system of a shop.

According to certain embodiments, the electronic device may be part of at least one of an item of furniture or a building/structure including an antenna. The electronic device may be an electronic board, an electronic signature input device, a projector, or any of various measurement machines (e.g., water supply, electricity, gas, propagation measurement machine, etc.). The electronic device may be one or more combinations of the aforementioned various devices. In addition, the electronic device may be a flexible device. Moreover, the electronic device is not limited to the aforementioned devices.

Hereinafter, an electronic device according to various embodiments will be described with reference to the accompanying drawings. The term ‘user’ used in the various embodiments may refer to a person who uses the electronic device or a device which uses the electronic device (e.g., an artificial intelligence (AI) electronic device).

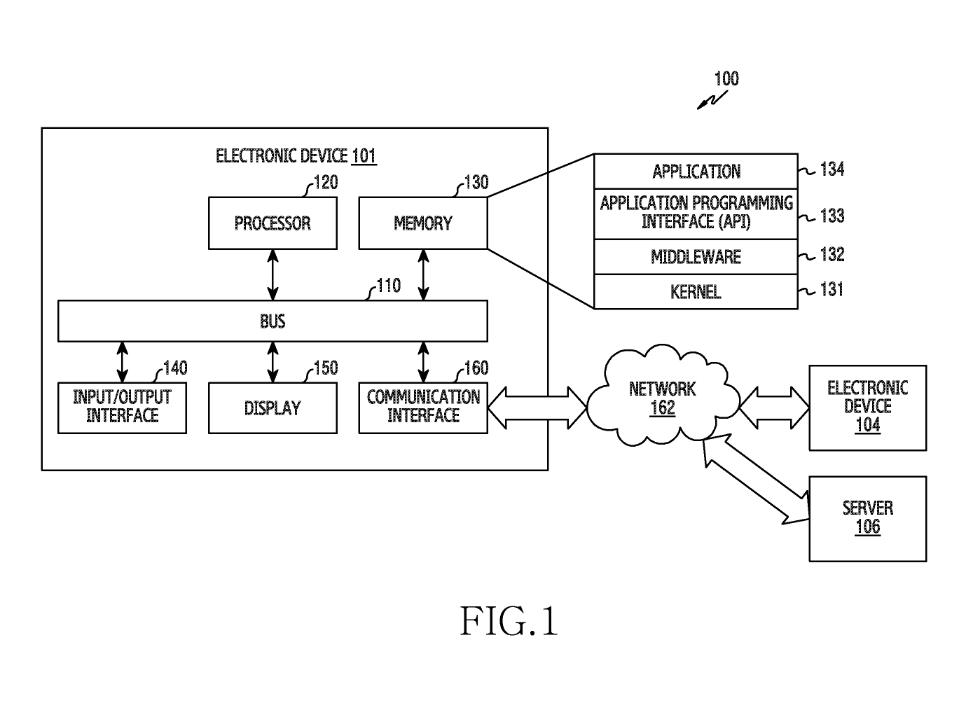

Specifically, FIGS. 1 through 8, discussed below, and the various embodiments used to describe the principles of the present disclosure in this patent document are by way of illustration only and should not be construed in any way that would limit the scope of the disclosure. Those skilled in the art will understand that the principles of the present disclosure may be implemented in any suitably arranged communications system. The terms used to describe various embodiments are exemplary. It should be understood that these are provided to merely aid the understanding of the description, and that their use and definitions in no way limit the scope of the present disclosure. Terms first, second, and the like are used to differentiate between objects having the same terminology and are in no way intended to represent a chronological order, unless where explicitly stated otherwise. A set is defined as a non-empty set including at least one element.

FIG. 1 illustrates a network environment including an electronic device according to an embodiment of the present disclosure.

Referring to FIG. 1, a network environment 100 including an electronic device 101 is illustrated, where the electronic device 101 may include a bus 110, a processor 120, a memory 130, an input/output interface 140, a display 150, and a communication interface 160.

The bus 110 may be a circuit for connecting the aforementioned constitutional elements to each other and for delivering communication (e.g., a control message) between the aforementioned constitutional elements.

The processor 120 may receive an instruction from the aforementioned different constitutional elements (e.g., the memory 130, the input/output interface 140, the display 150, the communication interface 160, etc.), for example, via the bus 110, and thus may interpret the received instruction and execute arithmetic or data processing according to the interpreted instruction.

The memory 130 may store an instruction or data received from the processor 120 or different constitutional elements (e.g., the input/output interface 140, the display 150, the communication interface 160, etc.) or generated by the processor 120 or the different constitutional elements. The memory 130 may include programming modules such as a kernel 131, a middleware 132, an application programming interface (API) 133, an application 134, and the like. Each of the aforementioned programming modules may consist of software, firmware, or hardware entities or may consist of at least two or more combinations thereof.

The kernel 131 may control or manage the remaining other programming modules, for example, system resources (e.g., the bus 110, the processor 120, the memory 130, etc.) used to execute an operation or function implemented in the middleware 132, the API 133, or the application 134. In addition, the kernel 131 may provide a controllable or manageable interface by accessing individual constitutional elements of the electronic device 101 in the middleware 132, the API 133, or the application 134.

The middleware 132 may perform a mediation role so that the API 133 or the application 134 communicates with the kernel 131 to exchange data. In addition, regarding task requests received from the application 134, for example, the middleware 132 may perform a control (e.g., scheduling or load balancing) for the task requests by using a method of assigning a priority capable of using a system resource (e.g., the bus 110, the processor 120, the memory 130, etc.) of the electronic device 101 to at least one of the applications 134.

The API 133 may include at least one interface or function (e.g., instruction) for file control, window control, video processing, character control, and the like, as an interface capable of controlling a function provided by the application 134 in the kernel 131 or the middleware 132.

The application 134 may include an short message service (SMS)/multimedia messaging service (MMS) application, an e-mail application, a calendar application, an alarm application, a health care application (e.g., an application for measuring a physical activity level, a blood sugar, etc.) or an environment information application (e.g., atmospheric pressure, humidity, or temperature information). Additionally or alternatively, the application 134 may be an application related to an information exchange between the electronic device 101 and an external electronic device (e.g., an electronic device 104 or server 106). The application related to the information exchange may include, for example, a notification relay application for relaying specific information to the external electronic device or a device management application for managing the external electronic device.

For example, the notification relay application may include a function of relaying notification information generated in another application (e.g., an SMS/MMS application, an e-mail application, a health care application, an environment information application, etc.) of the electronic device 101 to the external electronic device. Additionally or alternatively, the notification relay application may receive notification information, for example, from the external electronic device and may provide it to the user. The device management application may manage, for example, a function for at least one part of the external electronic device which communicates with the electronic device 101. Examples of the function include turning on/turning off the external electronic device itself (or some components thereof) or adjusting of a display illumination (or a resolution), and managing (e.g., installing, deleting, or updating) an application which operates in the external electronic device or a service (e.g., a call service or a message service) provided by the external electronic device.

The application 134 may include an application specified according to attribute information (e.g., an electronic device type) of the external electronic device. For example, if the external electronic device is an MP3 player, the application 134 may include an application related to a music play. Similarly, if the external electronic device is a mobile medical device, the application 134 may include an application related to a health care. The application 134 may include at least one of a specified application in the electronic device 101 or an application received from the external electronic device.

The input/output interface 140 may relay an instruction or data input from a user by using a sensor (e.g., an acceleration sensor, a gyro sensor) or an input device (e.g., a keyboard or a touch screen) to the processor 120, the memory 130, or the communication interface 160, for example, via the bus 110. For example, the input/output interface 140 may provide data regarding a user's touch input via the touch screen to the processor 120. In addition, the input/output interface 140 may output an instruction or data received from the processor 120, the memory 130, or the communication interface 160 to an output device (e.g., a speaker or a display), for example, via the bus 110. For example, the input/output interface 140 may output audio data provided by using the processor 120 to the user via the speaker.

The display 150 may display a variety of information (e.g., multimedia data or text data) to the user.

The communication interface 160 may connect a communication between the electronic device 101 and an external device (e.g., the electronic device 104 or the server 106). The communication interface 160 may include an antenna, examples of which are described hereinafter. For example, the communication interface 160 may communicate with the external device by being connected with a network 162 through wireless communication or wired communication. The wireless communication may include, for example, at least one of wireless fidelity (Wi-Fi), Bluetooth (BT), near field communication (NFC), GPS, and cellular communication (e.g., long term evolution (LTE), LTE-advanced (LTE-A), code division multiple access (CDMA), wideband CDMA (WCDMA), universal mobile telecommunications system (UMTS), wireless broadband (WiBro), global system for mobile communications (GSM), etc.). The wired communication may include, for example, at least one of universal serial bus (USB), high definition multimedia interface (HDMI), Recommended Standard (RS)-232, and plain old telephone service (POTS).

The network 162 may be a telecommunications network. The telecommunications network may include at least one of a computer network, an internet, an internet of things, and a telephone network. A protocol (e.g., a transport layer protocol, a data link layer protocol, or a physical layer protocol) for communication between the electronic device 101 and an external device may be supported in at least one of the application 134, the API 133, the middleware 132, the kernel 131, and the communication interface 160.

Various embodiments of the present disclosure apply an antenna radiator to a waterproof tape applied to an internal part of an electronic device for the purpose of waterproof, but are not limited to this. For instance, the various embodiments of the present disclosure may be applied to a sealing tape applied to the internal part of the electronic device for the purpose of shock absorption, dust resistance, contamination resistance, etc.

The various embodiments of the present disclosure illustrate a wrist wearable electronic device and describe a construction in which an antenna radiator is applied to a waterproof tape applied for the purpose of waterproof, but are not limited to this. For instance, it is obvious that the various embodiments of the present disclosure are applicable to various general communication electronic devices to which various kinds of sealing tapes are applied.

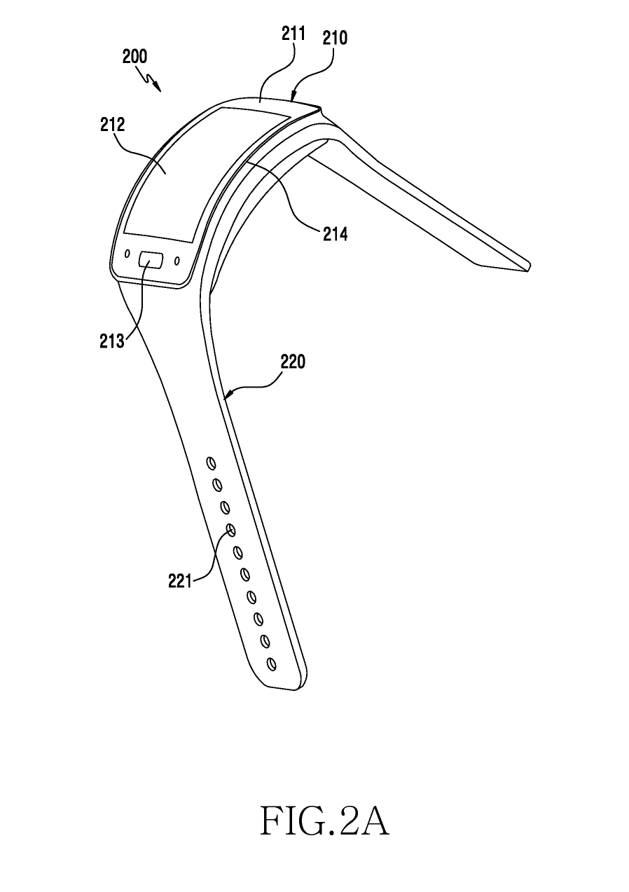

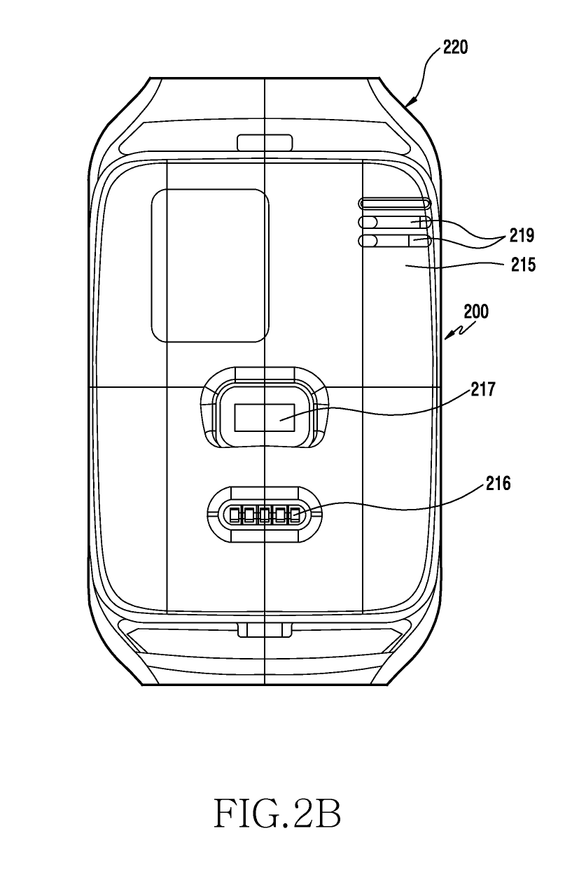

FIGS. 2A and 2B are diagrams illustrating constructions of a front surface and a rear surface of an electronic device according to various embodiments of the present disclosure.

Referring to FIGS. 2A and 2B, an electronic device 200 is illustrated, where the electronic device 200 is a wrist wearable electronic device capable of being worn on a user's wrist. According to an embodiment, the electronic device 200 may include a body 210 and a connection part (e.g., a strap) 220 on which the body 210 is mounted. According to an embodiment, the electronic device 200 may be worn in a manner of winding the connection part 220 on the wrist with putting the body 210 on the wrist. The connection part 220 may include a plurality of wrist controlling openings 221 at certain intervals to control a wearing position of the wrist wearable electronic device suitable to the user's wrist. According to an embodiment, the connection part 220 may be formed of at least one material among metal, leather, rubber, silicon, and urethane.

According to various embodiments, the body 210 may include a display 212 on a front surface 211. The display 212 may be applied in a touch screen manner. According to an embodiment, at least one key button 213 may be arranged in a suitable place of the body 210. According to an embodiment, the electronic device 200 may apply a battery (e.g., a chargeable battery, etc.) as a power supplying means in an internal part thereof, and may be selectively mounted on a predetermined portable charging cradle to charge the battery. According to various embodiments, a rear surface 215 of the body 210 of the electronic device 200 may include a plurality of terminals 216 capable of coming in physical and electrical contact with connector pins of the aforementioned cradle. According to an embodiment, the terminals 216 may be exposed to the rear surface 215 of the body 210. However, the terminals 216 may be arranged to be consistent with or lower than the rear surface 215. According to an embodiment, the rear surface 215 of the body 210 may further include a heart rate measuring sensor 217 for user's health care when the electronic device 200 is worn on the user's wrist. But, it is not limited to this, and various electrical sensor devices may be applied as well. According to an embodiment, the rear surface 215 of the body 210 may include a speaker hole 219 for discharging out a speaker sound outputted through a speaker included in the internal part of the electronic device 200. According to an embodiment, though not illustrated, a microphone hole may be also formed in a position corresponding to a microphone arranged in the internal part of the electronic device 200 in a suitable place of the electronic device 200 in order to accept a user's voice.

According to various embodiments, the electronic device 200 may interwork with another electronic device and be used together in a certain communication scheme. According to an embodiment, the electronic device 200 may also use a short-range communication module such as BT, etc. to perform wireless communication with another electronic device. But, it is not limited to this, and the electronic device 200 may include a communication module and an antenna apparatus and may be singly used as a communication electronic device.

According to various embodiments, the electronic device 200 may include a metal bezel 214 which contributes to an appearance of the body 210 and is used as a decoration member. According to an embodiment, the metal bezel 124 may be formed in such a manner that it surrounds a frame of the display 212.

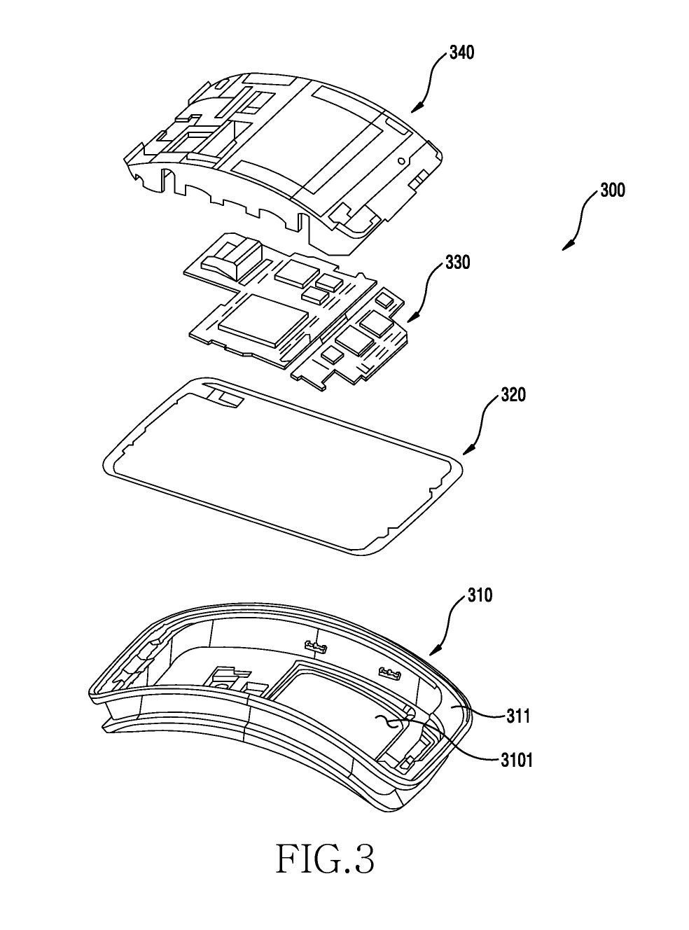

FIG. 3 is an exploded perspective diagram illustrating an electronic device according to an embodiment of the present disclosure.

Referring to FIG. 3, an electronic device 300 is illustrated, where the electronic device 300 may include an external housing 310 including a component mounting space 3101, and a tape member 320, a substrate 330, and an internal housing 340 (e.g., a bracket, etc.) which are sequentially mounted within the component mounting space 3101 of the external housing 310. Though not illustrated, a display may be mounted on an upper part of the internal housing 340. The electronic device 300 of FIG. 3 may be an electronic device similar to or different from the electronic device 200 of FIG. 2A

According to various embodiments, a tape recess portion 311 may be formed along an edge of the component mounting space 3101 of the external housing 310. According to an embodiment, the tape member 320 may be arranged in the tape recess portion 311. According to an embodiment, the tape member 320 may be assembled in a manner that the internal housing 340 or an upper housing (not shown) is closely adhered to an upper part of the tape member 320, to contribute to a sealing effect. According to an embodiment, the tape member 320 may be used for the purpose of waterproof, dust resistance, contamination resistance, shock absorption, etc.

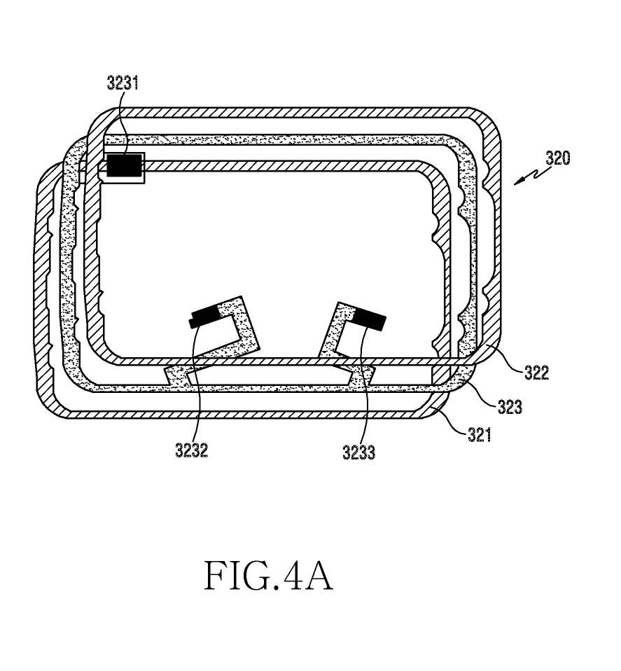

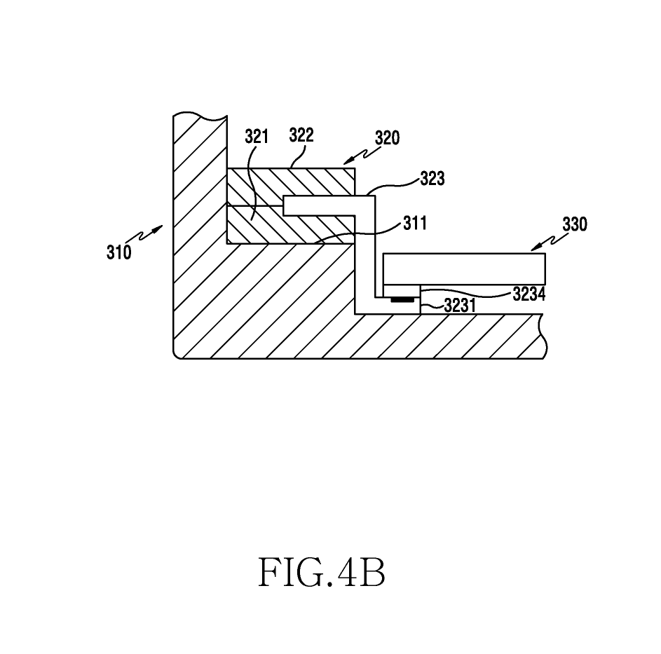

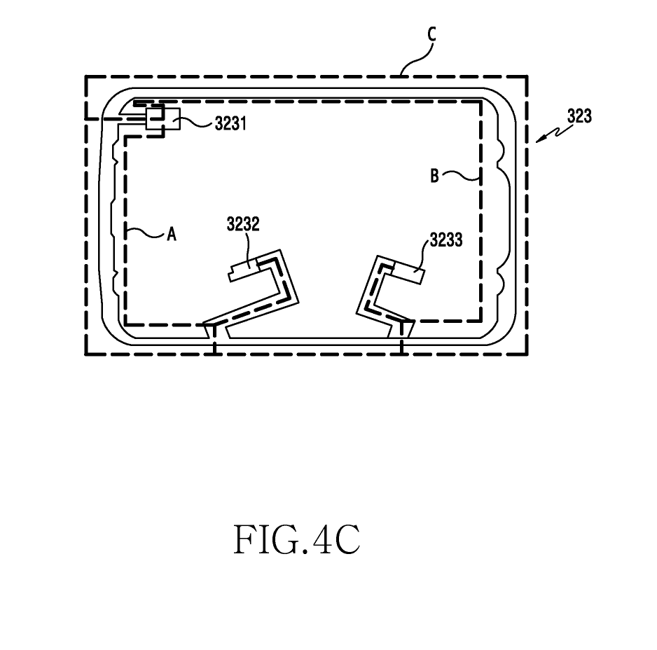

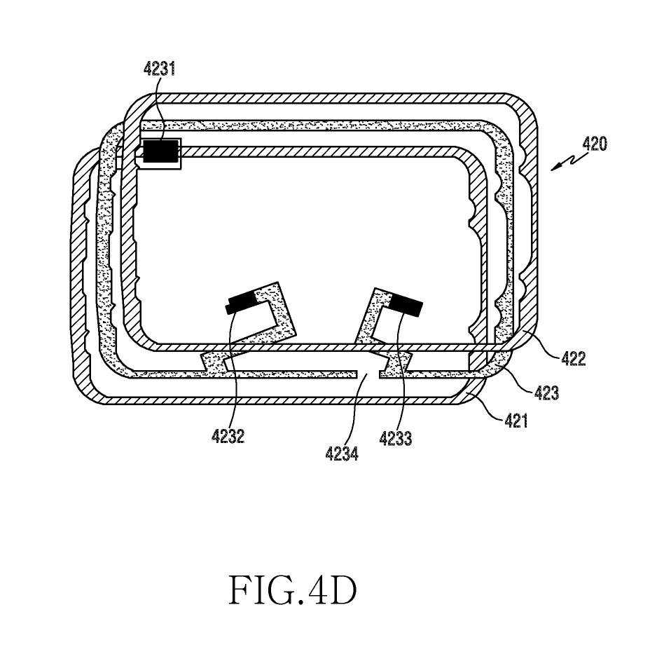

According to various embodiments, the tape member 320 may include an antenna member (323 of FIG. 4A). According to an embodiment, if the tape member 320 is completed, the antenna member is not protruded outside, and only its electrical connection portion for electrically connecting to the substrate 330 may be exposed. This construction will be described in more detail.

According to various embodiments of the present disclosure, the electronic device 300 has a construction in which the antenna member is included in the tape member 320, so there is no need to prepare a separate antenna mounting space within the electronic device 300. Accordingly, the electronic device 300 may mount other parts or reduce a total volume of the electronic device 300, resultantly contributing to the slimness of the electronic device 300.

FIG. 4A is a diagram illustrating a construction of a tape member including an antenna member according to an embodiment of the present disclosure.

Referring to FIG. 4A, a tape member 320 is illustrated, where the tape member 320 may be attached in a manner that a first tape member 321 and a second tape member 322 are formed in a double sided tape way and come in contact with each other in the mutually same area. According to an embodiment, an antenna member 323 may be interposed between the first tape member 321 and the second tape member 322. According to an embodiment, the antenna member 323 may be double-sided-taping processed as well. But, it is not limited to this and, though the antenna member 323 is not double-sided-taping processed, the antenna member 323 may be also fixed by forming a width of the antenna member 323 smaller than widths of the first and second tape members 321 and 322 and adhering the first and second tape members 321 and 322 with interposing the antenna member 323 therebetween.

According to various embodiments, the antenna member 323 may include one feeding part 3231, and first and second grounding parts 3232 and 3233 arranged in different positions. According to various embodiments, although the antenna member 323 is hidden by the first and second tape members 321 and 322, the feeding part 3231 and the first and second grounding parts 3232 and 3233 may be formed to extend outside the tape member 320 by a certain length. This is for bending and fixing the extended feeding part 3231 and first and second grounding parts 3232 and 3233 from the recess portion 311 to a bottom surface of the internal housing 310 and physically and electrically connecting the feeding part 3231 and first and second grounding parts 3232 and 3233 to corresponding regions of the substrate 330 mounted on an upper part thereof.

According to various embodiments, the antenna member 323 may contribute to a multiple band antenna radiator. According to an embodiment, the antenna member 323 may include antenna radiation regions capable of operating in different frequency bands by differently arranging a distance (i.e., an electrical length) of one direction between the feeding part 3231 of the antenna member 323 and the first grounding part 3232 and a distance (i.e., an electrical length) of another direction between the feeding part 3231 of the antenna member 323 and the second grounding part 3233.

According to an embodiment, the operation frequency band in each radiation region may be controlled by a change of grounding positions of the first and second grounding parts 3232 and 3233 of the antenna member 323. According to an embodiment, the antenna member 323 may be a metal plate of a thin film, or be a flexible printed circuit including a certain radiation pattern, or be a conductive spray coated in a certain radiation pattern on an adhesion surface of the first tape member 321 and/or the second tape member 322.

FIG. 4B is a cutaway perspective diagram illustrating a state in which a tape member is installed in an electronic device according to an embodiment of the present disclosure.

Referring to FIG. 4B, a tape member 320 is illustrated, where the tape member 320 may be attached to a tape recess portion 311 of an external housing 310. The tape member 320 may be fixed in a manner that a first tape member 321 and a second tape member 322 come in contact with each other, and an antenna member 323 may be interposed between the first tape member 321 and the second tape member 322. According to an embodiment, a feeding part 3231 of the antenna member 323 may be extended and formed outside the first and second tape members 321 and 322 and be expanded to a bottom surface of the external housing 310, and be physically and electrically connected to a corresponding region of a substrate 330 arranged on an upper part thereof.

According to various embodiments, the feeding part 3231 may be fixed to the bottom surface of the external housing 310 in a way of bonding, soldering, etc., and the substrate 330 and the feeding part 3231 may be electrically connected with each other through only an assembly process of installing the substrate 330 on the external housing 310. According to an embodiment, an electrical connection member 3234 may be interposed between the substrate 330 and the feeding part 3231, for the sake of firm, physical and electrical connection between the substrate 330 and the feeding part 3231. According to an embodiment, the electrical connection member 3234 may apply a conductive poron tape, a conductive sponge, a conductive tape, a conductive gasket, etc. According to an embodiment, in case that the electrical connection member 3234 is applied to the substrate 330, a C-clip, a connector pin, etc. mounted in the direction of the feeding part 3231 of the antenna member 323 in a corresponding position (e.g., a substrate feeding part) of the substrate 330 may be applied.

According to various embodiments, two grounding parts 3232 and 3233, as illustrated in FIG. 4A, as well as the feeding part 3231 drawn from the antenna member 323 may be also electrically connected with the substrate 330 in the same way. According to an embodiment, the two grounding parts 3232 and 3233 are constructed, but one or three or more grounding parts may be constructed or some of a plurality of grounding parts may be used as parasitic elements as well without coming in physical contact with the substrate 330.

FIG. 4C is a diagram illustrating a region by each operation frequency band in a case where an antenna member operates in a multiple band according to an embodiment of the present disclosure.

Referring to FIG. 4C, a radiation region is illustrated, where the radiation region consists of a grounding part having a shorter physical length from a feeding part 3231 may operate in a high frequency band compared to a radiation region consisting of the remnant one grounding part.

According to various embodiments, because a physical distance between the feeding part 3231 and a first grounding part 3232 is shorter than a physical distance between the feeding part 3231 and a second grounding part 3233, a loop antenna region ‘A’ consisting of the feeding part 3231, the first grounding part 3232 and the substrate 330, as illustrated in FIG. 4B, may operate in a high frequency band compared to a loop antenna region ‘B’ consisting of the feeding part 3231, the second grounding part 3233, and the substrate 330. According to an embodiment, if an antenna member 323 is formed to have a closed loop shape, the whole region of the antenna member 323 may contribute to another radiation region ‘C.’ According to an embodiment, by this radiation region ‘C,’ the antenna member 323 may be used as a Planar Inverted-F Antenna (PIFA) using the first grounding part 3232 and the second grounding part 3233.

FIG. 4D is a diagram illustrating a construction of a tape member according to an embodiment of the present disclosure.

Referring to FIG. 4D, a tape member 420 is illustrated, where the tape member 420 may include a first tape member 421 and a second tape member 422. According to an embodiment, an antenna member 423 may be interposed between the first tape member 421 and the second tape member 422. According to an embodiment, one feeding part 4231 of the antenna member 423 and two grounding parts 4232 and 4233 thereof may be extended outside identically with the aforementioned. According to an embodiment, a cutting part 4234 may be included between the two grounding parts 4232 and 4233. According to an embodiment, although the cutting part 4234 is formed, the antenna member 423 may contribute as a multiple band antenna radiator identically with the antenna member 323 of FIG. 4A.

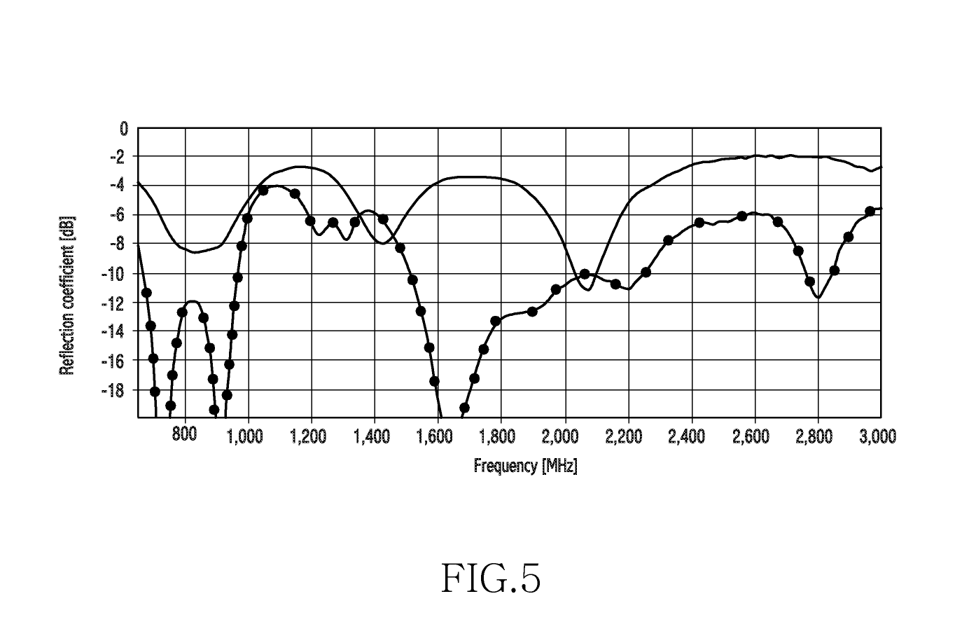

FIG. 5 is a graph showing a radiation characteristic in a case where an antenna member operates in multiple bands according to an embodiment of the present disclosure. It might be checked that the antenna member operates suitable to a reflection coefficient characteristic in each resonance mode. The graph of FIG. 5 illustrates a reflection coefficient measured in decibels (dB) vs. a frequency measured in megahertz (MHz) of an antenna member.

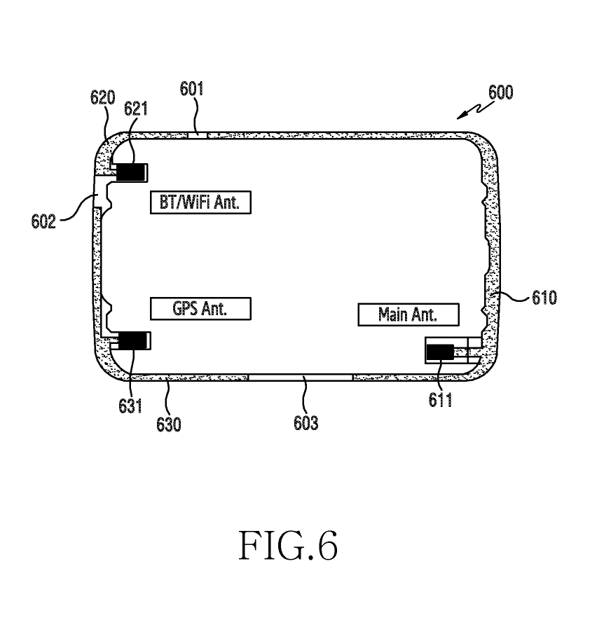

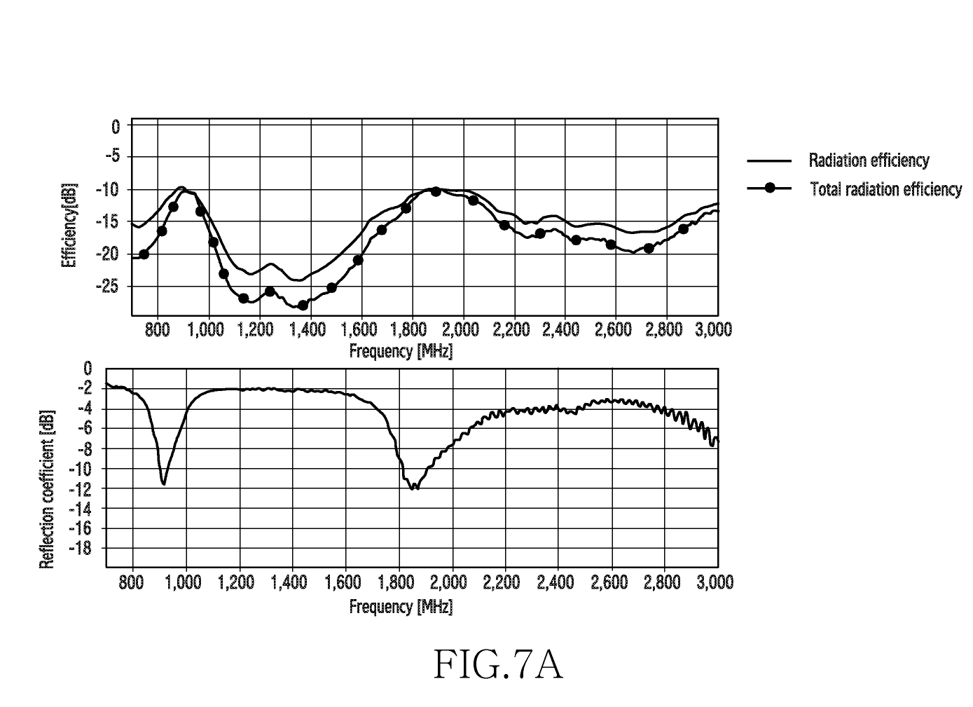

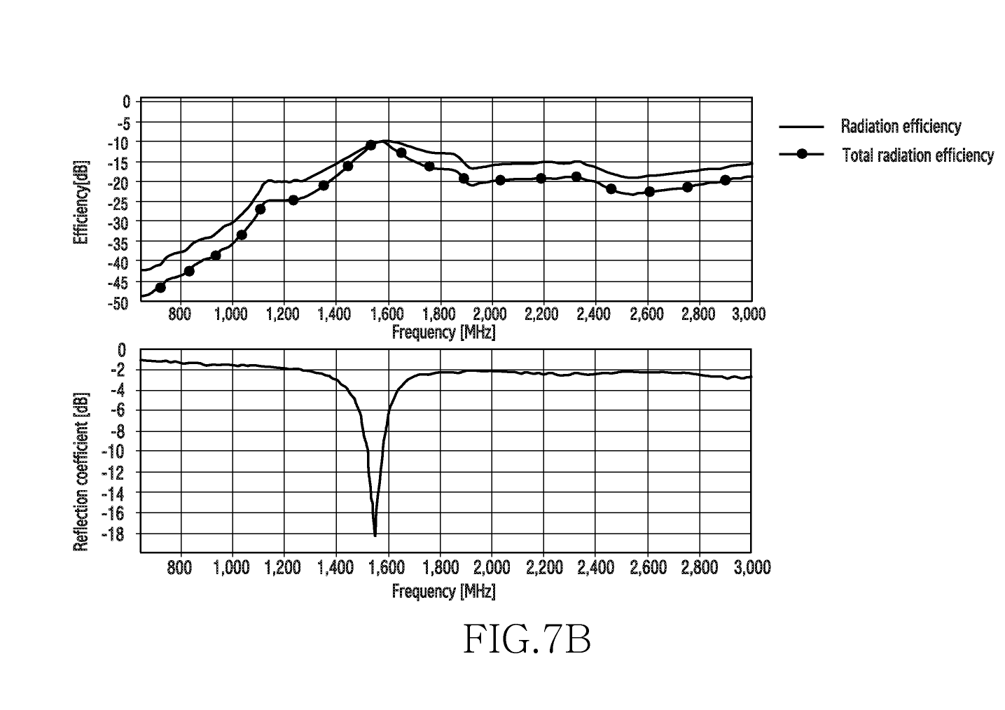

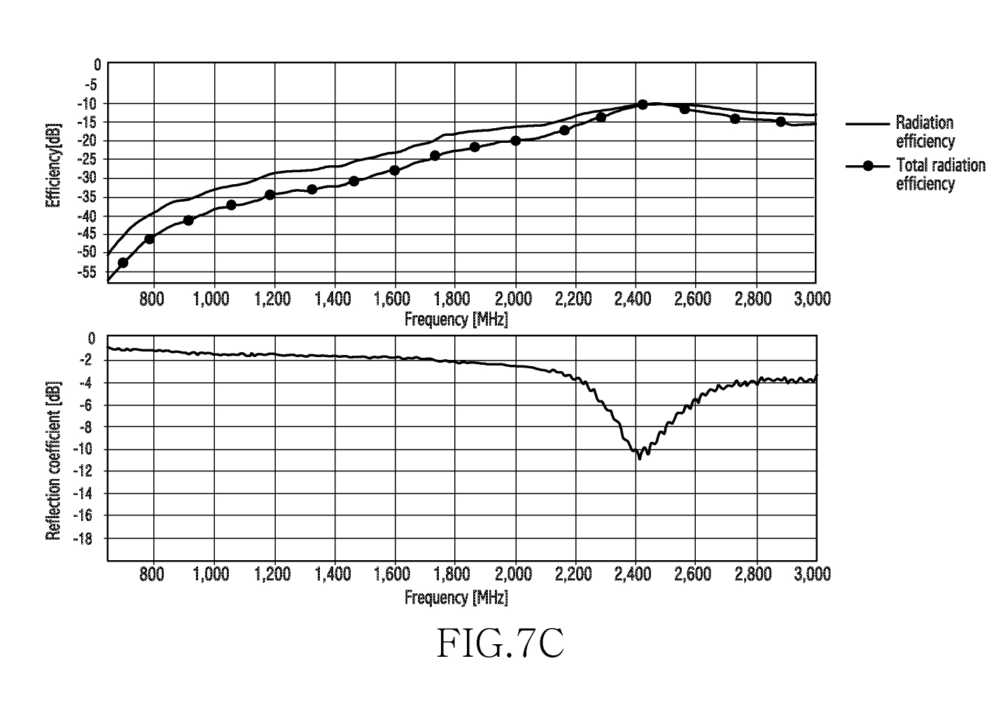

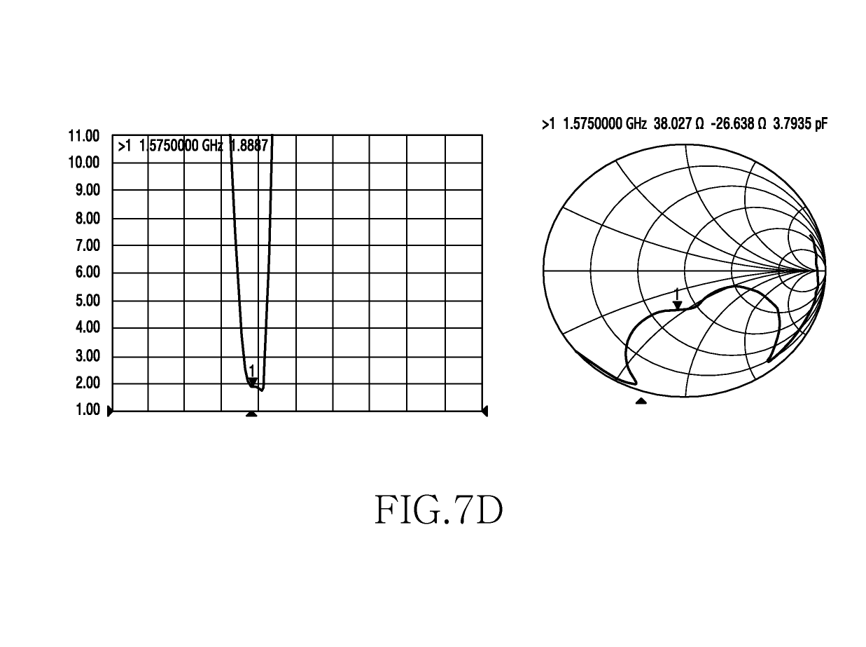

FIG. 6 is a diagram illustrating a construction of an antenna member applied to a tape member according to an embodiment of the present disclosure. Further, FIG. 7A to FIG. 7D are graphs showing a radiation characteristic of each radiation region of the antenna member of FIG. 6 according to various embodiments of the present disclosure. In describing the drawings, the tape member was omitted, but a construction in which the antenna member 600 is applied to the tape member is identical with the aforementioned.

Referring to FIG. 6, an antenna member 600 is illustrated, where the antenna member 600 may use a plurality of cutting parts 601, 602, and 603 to isolate a plurality of radiators 610, 620, and 630 operating in different frequency bands, but may arrange the radiators 610, 620, and 630 on a locus of the tape member. According to an embodiment, the antenna member 600 may include the first antenna radiator 610 formed by the first cutting part 601 and the third cutting part 603. According to an embodiment, the antenna member 600 may include the second antenna radiator 620 formed by the first cutting part 601 and the second cutting part 602. According to an embodiment, the antenna member 60 may include the third antenna radiator 630 formed by the second cutting part 602 and the third cutting part 603. According to an embodiment, the first antenna radiator 610 may contribute as a communication main antenna radiator, and the second antenna radiator 620 may contribute as a BT or WiFi antenna radiator, and the third antenna radiator 630 may contribute as a GPS antenna radiator.

According to various embodiments, a first feeding part 611 for the first antenna radiator 610 may be extended and formed outside of the antenna member 600, a second feeding part 621 for the second antenna radiator 620 may be extended and formed outside of the antenna member 600, and a third feeding part 631 for the third antenna radiator 630 may be extended and formed outside of the antenna member 600. Commonly, each of the feeding parts 611, 621, and 631 may be physically and electrically connected with the substrate 330 by the construction illustrated in FIG. 4B.

According to various embodiments, the third antenna radiator 630 used as the GPS antenna radiator is implemented in a circular polarization antenna radiation form being mutually vertical to face left/right corners at the same feeding part and thus, may receive a GPS signal more efficiently.

Referring to FIGS. 7A to 7D, it could be appreciated that a smooth radiation operation is carried out in a corresponding frequency band exhibited by each antenna radiator. The graphs of FIGS. 7A to 7D illustrate an efficiency measured in dB vs. a frequency measured in MHz to demonstrate radiation efficiency and total radiation efficiency, and illustrate a reflection coefficient measured in dB vs. a frequency measured in MHz of an antenna member.

According to various embodiments, an antenna member may be applied to an existing structure (e.g., a waterproof tape, etc.), thereby making possible the security of other component space caused by the exclusion of a separate antenna mounting space, and reducing a manufacturing cost, and contributing to the slimness of an electronic device.

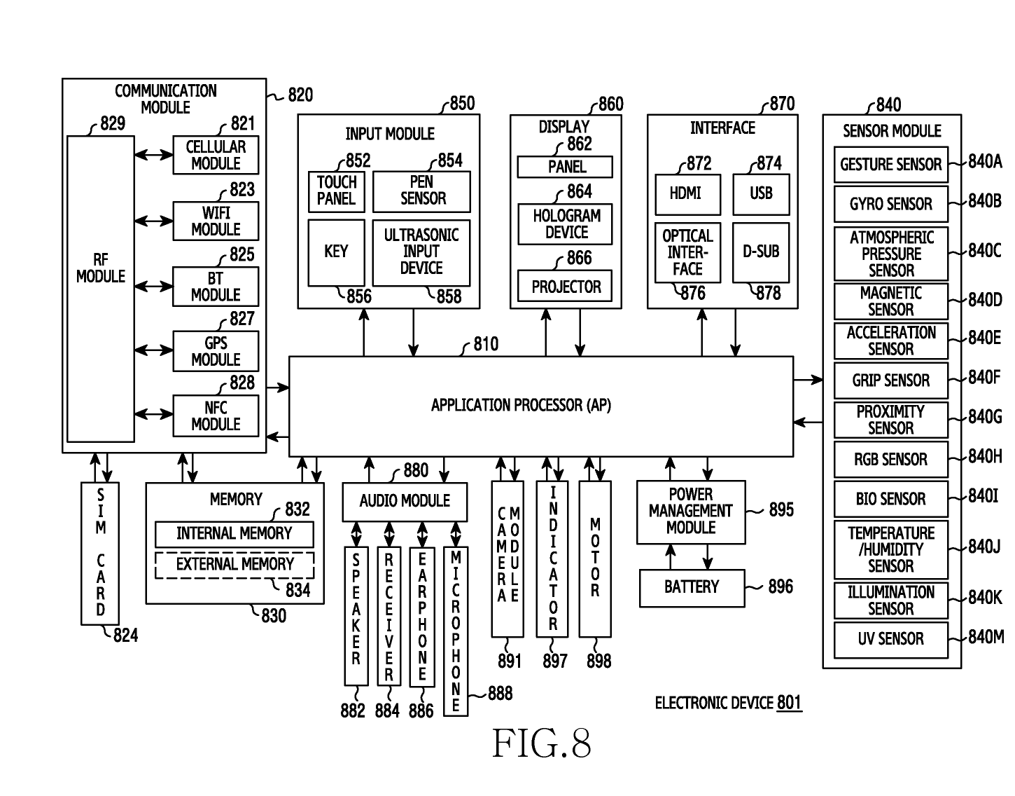

FIG. 8 is a block diagram illustrating a construction of an electronic device according to an embodiment of the present disclosure.

Referring to FIG. 8, a block diagram of an electronic device 801 is illustrated, where the electronic device 801 may entirely or partially constitute, for example, the electronic device 101 of FIG. 1, or the device 300 of FIG. 2B. The electronic device 801 includes at least one application processor (AP) 810, a communication module 820, a subscriber identification module (SIM) card 824, a memory 830, a sensor module 840, an input unit/module 850, a display 860, an interface 870, an audio module 880, a camera module 891, a power management module 895, a battery 896, an indicator 897, and a motor 898.

The AP 810 may control a plurality of hardware or software constitutional elements connected to the AP 810 by driving an operating system or an application program, and may process a variety of data including multimedia data and may perform an arithmetic operation. The AP 810 may be implemented, for example, with a system on chip (SoC). The AP 810 may further include a graphic processing unit (GPU, not shown).

The communication module 820 (e.g., the communication interface 160 of FIG. 1) may perform data transmission/reception in communication between other electronic devices (e.g., the electronic device 104 of FIG. 1 or the server 106 of FIG. 1) connected with the electronic device 801 (e.g., the electronic device 101 of FIG. 1) through a network. The communication module 820 may include a cellular module 821, a Wi-Fi module 823, a BT module 825, a GPS module 827, a NFC module 828, and a radio frequency (RF) module 829.

The cellular module 821 may provide a voice call, a video call, a text service, an internet service, and the like through a communication network (e.g., LTE, LTE-A, CDMA, WCDMA, UMTS, WiBro, GSM, etc.). In addition, the cellular module 821 may identify and authenticate the electronic device within the communication network by using a subscriber identity module (e.g., the SIM card 824). The cellular module 821 may perform at least some of functions that can be provided by the AP 810. For example, the cellular module 821 may perform at least some of multimedia control functions.

The cellular module 821 may include a communication processor (CP). Further, the cellular module 821 may be implemented, for example, with an SoC. Although constitutional elements such as the cellular module 821 (e.g., the CP), the memory 830, the power management module 895, and the like are illustrated as separate constitutional elements with respect to the AP 810 in FIG. 8, the AP 810 may also be implemented such that at least one part (e.g., the cellular module 821) of the aforementioned constitutional elements is included.

The AP 810 or the cellular module 821 (e.g., the CP) may load an instruction or data, which is received from each non-volatile memory connected thereto or at least one of different constitutional elements, to a volatile memory and may process the instruction or data. In addition, the AP 810 or the cellular module 821 may store data, which is received from at least one of different constitutional elements or generated by at least one of different constitutional elements, into the non-volatile memory.

Each of the WiFi module 823, the BT module 825, the GPS module 827, and the NFC module 828 may include, for example, a processor for processing data transmitted/received through a corresponding module. Although the cellular module 821, the WiFi module 823, the BT module 825, the GPS module 827, and the NFC module 828 are illustrated in FIG. 8 as separate blocks, according to an embodiment, at least some (e.g., two or more) of the cellular module 821, the WiFi module 823, the BT module 825, the GPS module 827, and the NFC module 828 may be included in one integrated chip (IC) or IC package. For example, at least some of processors corresponding to the cellular module 821, the WiFi module 823, the BT module 825, the GPS module 827, and the NFC module 828 (e.g., a CP corresponding to the cellular module 821 and a WiFi processor corresponding to the WiFi module 823) may be implemented with an SoC.

The RF module 829 may serve to transmit/receive data, for example, to transmit/receive an RF signal. Although not shown, the RF module 829 may include, for example, a transceiver, a power amp module (PAM), a frequency filter, a low noise amplifier (LNA), and the like. In addition, the RF module 829 may further include a component for transmitting/receiving a radio wave on a free space in wireless communication, for example, a conductor, a conducting wire, and the like. Although it is illustrated in FIG. 8 that the cellular module 821, the WiFi module 823, the BT module 825, the GPS module 827, and the NFC module 828 share one RF module 829, according to an embodiment, at least one of the cellular module 821, the WiFi module 823, the BT module 825, the GPS module 827, the NFC module 828 may transmit/receive an RF signal via a separate RF module.

The SIM card 824 may be a card in which a SIM is implemented, and may be inserted to a slot formed at a specific location of the electronic device. The SIM card 824 may include unique identification information (e.g., an integrated circuit card identifier (ICCID)) or subscriber information (e.g., an international mobile subscriber identity (IMSI)).

The memory 830 (e.g., the memory 130 of FIG. 1) may include an internal memory 832 or an external memory 834. The internal memory 832 may include, for example, at least one of a volatile memory (e.g., a dynamic random access memory (DRAM), a static RAM (SRAM), a synchronous dynamic RAM (SDRAM), etc.) or a non-volatile memory (e.g., a one time programmable read only memory (OTPROM), a programmable ROM (PROM), an erasable and programmable ROM (EPROM), an electrically erasable and programmable ROM (EEPROM), a mask ROM, a flash ROM, a NAND flash memory, a NOR flash memory, etc.).

The internal memory 832 may be a solid state drive (SSD). The external memory 834 may further include a flash drive, and may further include, for example, compact flash (CF), secure digital (SD), Micro-SD, Mini-SD, extreme digital (xD), memory stick, and the like. The external memory 834 may be operatively coupled to the electronic device 801 via various interfaces. The electronic device 801 may further include a storage unit (or a storage medium) such as a hard drive.

The sensor module 840 may measure a physical quantity or detect an operation state of the electronic device 801, and thus may convert the measured or detected information into an electric signal. The sensor module 840 may include, for example, at least one of a gesture sensor 840A, a gyro sensor 840B, an atmospheric pressure sensor 840C, a magnetic sensor 840D, an acceleration sensor 840E, a grip sensor 840F, a proximity sensor 840G, a color sensor 840H (e.g., a red, green, blue (RGB) sensor), a bio sensor 840I, a temperature/humidity sensor 840J, an illumination sensor 840K, and an ultraviolet (UV) sensor 840M. Additionally or alternatively, the sensor module 840 may include, for example, an E-node sensor (not shown), an electromyography (EMG) sensor (not shown), an electroencephalogram (EEG) sensor (not shown), an electrocardiogram (ECG) sensor (not shown), a fingerprint sensor, etc. The sensor module 840 may further include a control circuit for controlling at least one or more sensors included therein.

The input module 850 may include a touch panel 852, a (digital) pen sensor 854, a key 856, or an ultrasonic input unit 858. The touch panel 852 may recognize a touch input, for example, by using at least one of an electrostatic type, a pressure-sensitive type, and an ultrasonic type. The touch panel 852 may further include a control circuit. In case of the electrostatic type, not only a physical contact but also a proximity recognition is also possible. The touch penal 852 may further include a tactile layer. In this case, the touch panel 852 may provide the user with a tactile reaction.

The (digital) pen sensor 854 may be implemented, for example, by using the same or similar method of receiving a touch input of the user or by using an additional sheet for recognition. The key 856 may be, for example, a physical button, an optical key, a keypad, or a touch key. The ultrasonic input unit 858 is a device by which the electronic device 801 detects a sound wave through a microphone (e.g., a microphone 888) by using a pen which generates an ultrasonic signal, and is a device capable of radio recognition. The electronic device 801 may use the communication module 820 to receive a user input from an external device (e.g., a computer or a server) connected thereto.

The display 860 (e.g., the display 150 of FIG. 1) may include a panel 862, a hologram device 864, or a projector 866. The panel 862 may be, for example, a liquid-crystal display (LCD), an active-matrix organic light-emitting diode (AM-OLED), etc. The panel 862 may be implemented, for example, in a flexible, transparent, or wearable manner. The panel 862 may be constructed as one module with the touch panel 852. The hologram device 864 may use an interference of light and show a stereoscopic image in the air. The projector 866 may display an image by projecting a light beam onto a screen. The screen may be located, for example, inside or outside the electronic device 801. The display 860 may further include a control circuit for controlling the panel 862, the hologram device 864, or the projector 866.

The interface 870 may include, for example, a HDMI 872, a USB 874, an optical communication interface 876, or a D-subminiature (D-sub) 878. The interface 870 may be included, for example, in the communication interface 160 of FIG. 1. Additionally or alternatively, the interface 870 may include, for example, mobile high-definition link (MHL) (not shown), SD/multi-media card (MMC) (not shown) or Infrared Data Association (IrDA) (not shown).

The audio module 880 may bilaterally convert a sound and electric signal. At least some constitutional elements of the audio module 808 may be included in, for example, the input/output interface 140 of FIG. 1. The audio module 880 may convert sound information which is input or output, for example, through a speaker 882, a receiver 884, an earphone 886, the microphone 888, and the like.

The camera module 891 is a device for image and video capturing, and according to an embodiment, may include one or more image sensors (e.g., a front sensor or a rear sensor), a lens (not shown), an image signal processor (ISP) (not shown), or a flash (not shown, e.g., LED or xenon lamp).

The power management module 895 may manage power of the electronic device 801. Although not shown, the power management module 895 may include, for example, a power management integrated circuit (PMIC), a charger IC, or a battery fuel gauge.

The PMIC may be placed, for example, inside an IC or SoC semiconductor. Charging may be classified into wired charging and wireless charging. The charger IC may charge a battery, and may avoid an over-voltage or over-current flow from a charger. The charger IC may further include a charger IC for at least one of the wired charging and the wireless charging. The wireless charging may be classified, for example, into a magnetic resonance type, a magnetic induction type, and an electromagnetic type. An additional circuit for the wireless charging, for example, a coil loop, a resonant circuit, a rectifier, and the like, may be added.

The battery gauge may measure, for example, a residual quantity of the battery 896 and a voltage, current, and temperature during charging. The battery 896 may store or generate electricity, and may supply power to the electronic device 801 by using the stored or generated electricity. For example, the battery 896 may include a rechargeable battery or a solar battery.

The indicator 897 may indicate a specific state, for example, a booting state, a message state, a charging state, and the like, of the electronic device 801 or a part thereof (e.g., the AP 810). The motor 898 may convert an electric signal into a mechanical vibration. Although not shown, the electronic device 801 may include a processing unit (e.g., a GPU) for supporting mobile TV. The processing unit for supporting mobile TV may process media data according to a protocol of, for example, digital multimedia broadcasting (DMB), digital video broadcasting (DVB), media flow, and the like.

Each of the aforementioned constitutional elements of the electronic device according to various embodiments of the present disclosure may consist of one or more components, and names thereof may vary depending on a type of electronic device. The electronic device according to various embodiments of the present disclosure may include at least one of the aforementioned constitutional elements. Some of the constitutional elements may be omitted, or additional other constitutional elements may be further included. In addition, some of the constitutional elements of the electronic device according to various embodiments of the present disclosure may be combined and constructed as one entity, so as to equally perform functions of corresponding constitutional elements before combination.

A term “module” used in various embodiments of the present document may imply a unit including, for example, one of hardware, software, and firmware or a combination of two or more of them. The “module” may be interchangeably used with a term such as a unit, a logic, a logical block, a component, a circuit, and the like. The “module” may be a minimum unit of an integrally constituted component or may be a part thereof. The “module” may be a minimum unit for performing one or more functions or may be a part thereof. The “module” may be mechanically or electrically implemented. For example, the “module” of the present disclosure may include at least one of an application-specific IC (ASIC) chip, a field-programmable gate arrays (FPGAs), and a programmable-logic device, which are known or will be developed and which perform certain operations.

According to various embodiments, at least some parts of a device (e.g., modules or functions thereof) or method (e.g., operations) according to various embodiments of the present disclosure may be implemented with an instruction stored in a computer-readable storage media for example. If the instruction is executed by one or more processors (e.g., the processor 810), the one or more processors may perform a function corresponding to the instruction. The computer-readable storage media may be, for example, the memory 830. At least some parts of the programming module may be implemented (e.g., executed), for example, by the processor 810. At least some parts of the programming module may include modules, programs, routines, sets of instructions, processes, and the like, for performing one or more functions.

The computer readable recording medium may be a hardware device configured particularly to store and perform a program instruction (e.g., program module), for example, a hard disk, a magnetic medium such as a floppy disc and a magnetic tape, an optical storage medium such as a Compact Disc-ROM (CD-ROM) or a DVD, a magnetic-optic medium such as a floptical disc, a ROM, a RAM, a flash memory, and the like. An example of the program instruction includes not only a machine language created by a compiler but also a high-level language executable by a computer by using an interpreter or the like. The aforementioned hardware device may be configured to operate as one or more software modules to perform the operation of the present disclosure, and the other way around is also possible.

The module or programming module according to various embodiments of the present disclosure may further include at least one or more constitutional elements among the aforementioned constitutional elements, or may omit some of them, or may further include additional other constitutional elements. Operations performed by a module, programming module, or other constitutional elements according to various embodiments of the present disclosure may be executed in a sequential, parallel, repetitive, or heuristic manner. In addition, some of the operations may be executed in a different order or may be omitted, or other operations may be added.

While the present disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. An electronic device comprising:
a first housing;
a second housing coupled with the first housing;
at least two adhesive members disposed between a coupling face of the first housing and a coupling face of the second housing;
at least one electrically conductive member disposed between the at least two adhesive members; and
a substrate electrically connected with the electrically conductive member.

2. The electronic device of claim 1, wherein the electronic device is a wearable electronic device comprising a body including the first housing and the second housing, and a connection part for wearing the housing on a user's wrist.

3. The electronic device of claim 1, wherein the electronic device comprises a smart watch.

4. The electronic device of claim 1, wherein the at least one of the first housing and the second housing comprises a display.

5. The electronic device of claim 4, wherein the display comprises a touch display.

6. The electronic device of claim 1, wherein at least two adhesive members comprises double sided tape.

7. The electronic device of claim 1, wherein at least two adhesive members provide a seal between the first housing and the second housing.

8. The electronic device of claim 1, wherein at least two adhesive members provide shock adsorption between the first housing and the second housing.

9. The electronic device of claim 1, wherein the at least one electrically conductive member is disposed between a first adhesive member of the at least two adhesive members and a second adhesive member of the at least two adhesive members.

10. The electronic device of claim 1, wherein the at least one electrically conductive member comprise one of a metal plate of a thin film, a flexible printed circuit (FPC), and a conductive spray application.

11. The electronic device of claim 1, wherein the at least one electrically conductive member comprises an electrically conductive a ground conductive member and an electrically conductive signal line member.

12. The electronic device of claim 1, wherein the at least one electrically conductive member comprises at least two electrically conductive members that are not electrically connected.

13. The electronic device of claim 1, further comprising at least one extension configured to electrically and physically connect the at least one electrically conductive member to the substrate.

14. The electronic device of claim 1, wherein the substrate comprises a circuit electrically connected to the at least one electrically conductive member.

15. The electronic device of claim 1, wherein the at least one electrically conductive member comprises at least one antenna member.

16. An electronic device comprising:
a body comprising a first housing and a second housing coupled with the first housing;
a display disposed in at least one of the first housing and second housing;
at least two double sided tape members disposed between a coupling face of the first housing and a coupling face of the second housing;
at least one electrically conductive member disposed between the at least two double sided tape members;
a substrate comprising a circuit; and
at least one extension configured to electrically and physically connect the at least one electrically conductive member to the substrate,
wherein the at least one electrically conductive member is disposed between a first double sided tape member of the at least two double sided tape members and a second double sided tape member of the at least two double sided tape members.

17. The electronic device of claim 16, wherein the electronic device is a wearable electronic device comprising the body, and a connection part for wearing the housing on a user's wrist.

18. The electronic device of claim 16, wherein at least one of the at least two double sided tape members provide a seal between the first housing and the second housing.

19. The electronic device of claim 16, wherein at least one of the at least two double sided tape members provide shock adsorption between the first housing and the second housing.

20. The electronic device of claim 16, wherein the at least one electrically conductive member comprise one of a metal plate of a thin film, a flexible printed circuit (FPC), and a conductive spray application.

21. The electronic device of claim 16, wherein the at least one electrically conductive member comprises an electrically conductive a ground conductive member and an electrically conductive signal line member.

22. The electronic device of claim 16, wherein the at least one electrically conductive member comprises at least two electrically conductive members that are not electrically connected.

23. The electronic device of claim 16, wherein the at least one electrically conductive member comprises at least one antenna member.

24. An electronic device comprising:
a housing comprising a lower portion of the housing and an upper portion of the housing;
a plurality of adhesive members disposed between an edge of the lower portion of the housing and an edge of the upper portion of the housing;
at least one electrically conductive member disposed between an edge of the lower portion of the housing and an edge of the upper portion of the housing; and
a substrate electrically connected with the electrically conductive member.
